(19) United States
(12) Patent Application Publication
(10) Pub. No.: US 2010/0194910 A1
(43) Pub. Date: Aug. 5, 2010

(54) IMAGE PROCESSING APPARATUS FOR PERFORMING INTRA-FRAME PREDICTIVE CODING ON PICTURES TO BE CODED AND IMAGE PICKUP APPARATUS EQUIPPED WITH THE IMAGE PROCESSING APPARATUS

(76) Inventors: Yoshihiro Matsuo, Gifu City (JP); Shigeyuki Okada, Ogaki City (JP); Nobuo Nakai, Anpachi-Gun (JP)

Correspondence Address: MCDERMOTT WILL & EMERY LLP, 600 13TH STREET, N.W., WASHINGTON, DC, 20005-3096, US

(21) Appl. No.: 12/699,553

(22) Filed: Feb. 3, 2010

(30) Foreign Application Priority Data
Feb. 3, 2009 (JP) 2009-022845

(51) Int. Cl. H04N 5/228; H04N 7/32

(52) U.S. Cl. 348/222.1; 375/240.16; 348/E05.031; 375/E07.123

(57) ABSTRACT

A motion vector detector detect a motion vector of each macroblock in an I frame. A control unit controls a quantization unit in such manner that the quantization scale in a quantization table referenced in the quantization processing is adaptively varied for a first macroblock whose motion vector detected is smaller than a prescribed threshold value.

This application is based upon and claims the benefit of priority from the prior Japanese Patent Applications No. 2009-022845, filed Feb. 3, 2009, the entire contents of which are incorporated herein by reference.

### BACKGROUND OF THE INVENTION

1. Field of the Invention

The present invention relates to an image processing apparatus for processing moving images and an image pickup apparatus equipped with said image processing apparatus.

2. Description of the Related Art

In recent years, digital movie cameras capable of taking moving images have been widely in use. The digital movie cameras are achieving a higher image quality every year and those among them compatible with a full high definition image quality mode are now commercially available. With such advancement, a digital movie camera capable of compressing and coding the moving images in compliance with the H.264/AVC standard is also put to practical use.

In the H.264/AVC standard, a prediction error which is a difference between an inputted image and a predicted image is subjected to orthogonal transform and the thus derived orthogonal transform coefficients undergoes quantization.

The quantization of the orthogonal transform coefficients produces quantization error. Increasing the quantization scale improves the compression ratio but also increases the quantization error. A codestream according to the H.264/AV standard contains frames coded by the intra-frame prediction (hereinafter referred to as first frames or I frames as appropriate) and those coded by the forward inter-frame prediction (hereinafter referred to as second frames or P frames as appropriate). In the codestream, this adverse effect of quantization error is carried over as long as P frames coded by the inter-frame prediction are arranged contiguously. Thus, in such a case, the quantization error accumulates over time. If an I frame appears under this condition, the quantization error will be reset. This is because I frames are coded using the intra-frame prediction and therefore the I frames do not suffer from quantization noise. Larger the thus reset quantization error is, the larger the flicker occurring at the switching from a P frame to an I frame will be. This causes a subjective image quality degradation.

### SUMMARY OF THE INVENTION

One embodiment of the present invention relates to an image processing apparatus. The image processing apparatus comprises: a coding unit configured to detect a motion vector for each unit region of target picture when the target picture is subjected to intra-frame prediction coding; and a control unit configured to adaptively control a quantization processing performed by the coding unit for a first unit region whose size of the motion vector is smaller than a predetermined threshold value.

The control unit may control the coding unit in such a manner that a first quantization scale used in the quantization of the first unit region becomes small.

The control unit may control the coding unit in such a manner that a second quantization scale, used in the quantization of a second unit region, whose size of the motion vector is larger than the predetermined threshold value becomes large according as the first quantization scale used in the quantization of the first unit region becomes small.

Optional combinations of the aforementioned constituting elements, and implementations of the invention in the form of methods, apparatuses, systems, recording media, computer programs and the like may also be practiced as additional modes of the present invention.

### BRIEF DESCRIPTION OF THE DRAWINGS

Embodiments will now be described by way of examples only, with reference to the accompanying drawings which are meant to be exemplary, not limiting, and wherein like elements are numbered alike in several Figures in which:

FIG. 1 is a conceptual diagram illustrating a structure of an image pickup apparatus according to an embodiment of the present invention; and

FIG. 2 shows macroblocks, in an I frame, grouped according to the sizes of motion vectors.

### DETAILED DESCRIPTION OF THE INVENTION

The invention will now be described by reference to the preferred embodiments. This does not intend to limit the scope of the present invention, but to exemplify the invention.

An outline will be given of the present invention below before it is described in detail. An image processing apparatus according to a preferred embodiment of the present invention performs coding and compression in compliance with the H.264/AVC standard.

In the H.264/AVC standard, an image frame which has been subjected to intra-frame coding is called an I (intra) frame, one subjected to forward predictive coding between frames by referencing a frame in the past is called a P (predictive) frame, and one subjected to inter-frame predictive coding regardless of previous or future frames and the number of frames which can be used as reference images is called a B (bidirectionally-predictive) frame.

In this patent specification, “frame” and “picture” each indicates the same meaning and are used interchangeably. I frame, P frame and B frame are also called I picture, P picture and B picture, respectively. Also, frames are used as an example for explanation in this patent specification but a “field”, instead of “frame”, may be the unit for coding.

When a P frame undergoes inter-frame predictive coding, prediction error is derived from the difference between an image to be coded and a reference image in the past frames. Then quantized is orthogonal transform coefficients obtained when this prediction error has been subjected to the orthogonal transform. The quantized orthogonal transform coefficients are inverse-quantized and this inverse-quantized orthogonal transform coefficients undergoes inverse orthogonal transform. As a result, a restored image frame is generated. A reference image is generated based on the restored image frame. Thus, the quantization error accumulates as long as P frames are contiguous.

The first P frame undergoes inter-frame predictive coding using an I frame as a reference image. Thus it is desirable that the I frame be coded with as high image quality as possible in order to suppress the accumulation of quantization error. In particular, among macroblocks that constitute an I frame (hereinafter referred to as “unit region” as appropriate), those with little movement or with not much movement involved are often referenced from posterior P frames, so that the accumulation of quantization error can be reduced if such macroblocks with little movement or not much movement involved are coded with a high image quality.

In the light of this, the image processing apparatus according to an embodiment of the present invention detects a motion vector per macroblock even for 1 frames subjected to the intra-frame predictive coding, and adaptively controls the quantization scale for macroblocks having a small amount of movement therein.

Thus, a macroblock having a smaller amount of movement is coded with a higher image quality in I frames. As a result, the accumulation of quantization error at the time of coding P frames by referencing such a macroblock can be reduced and therefore the occurrence of the flicker at the switching from a P frame to an I frame can be restricted.

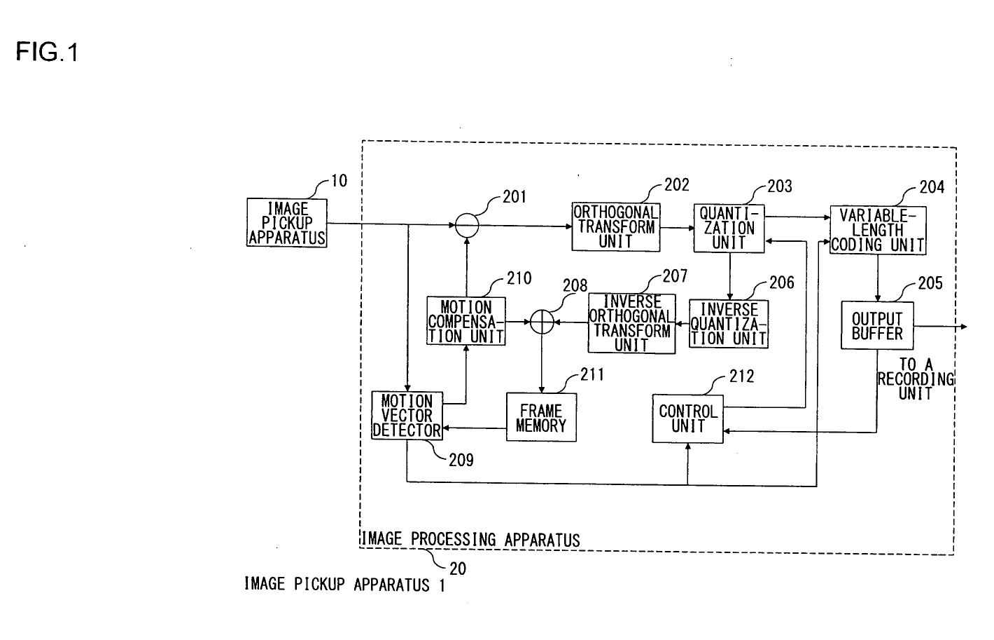

FIG. 1 is a conceptual diagram illustrating a structure of an image pickup apparatus 1 according to an embodiment of the present invention. The image pickup apparatus 1 includes an image pickup unit 10 and an image processing apparatus 20.

The image pickup unit 10 acquires moving images and supplies them to the image processing apparatus 20. The image pickup unit 10 includes solid-state image sensing devices, such as CCD (Charge-Coupled Devices) sensors and CMOS (Complementary Metal-Oxide Semiconductor) image sensors, and a signal processing unit. This signal processing unit converts three analog primary color signals outputted from the solid-state image sensing devices, into digital luminance signals and digital color-difference signals.

The image processing apparatus 20 compresses and codes the moving images acquired from the image pickup unit 10 in compliance with the H.264/AVC standard, for instance, and generates a codestream. Then the image processing apparatus 20 outputs the thus generated codestream to a not-shown recording unit. Examples of this recording unit include a hard disk drive (HDD), an optical disk and a flash memory.

The image processing unit 20 includes a difference unit 201, an orthogonal transform unit 202, a quantization unit 203, a variable-length coding unit 204, an output buffer 205, an inverse quantization unit 206, an inverse orthogonal transform unit 207, an adder 208, a motion vector detector 209, a motion compensation unit 210, a frame memory 211, and a control unit 212.

If an image frame inputted from the image pickup unit 10 is I frame, the difference unit 201 will output the received I frame directly to the orthogonal transform unit 202. If P or B frame, the difference unit 201 will calculate the difference between the P or B frame and prediction image inputted from the motion compensation unit 210 and output the difference therebtween to the orthogonal transform unit 202.

The orthogonal transform unit 202 performs discrete cosine transform (DCT) on a difference image inputted from the difference unit 201 and then outputs DCT coefficients to the quantization unit 203.

The quantization unit 203 quantizes the DCT coefficients, inputted from the orthogonal transform unit 202, by referencing a predetermined quantization table and then outputs the thus quantized DCT coefficients to the variable-length coding unit 204. The quantization table is a table that specifies a quantization scale with which to divide each DCT coefficient. In the quantization table, a quantization scale corresponding to a low-frequency component in the DCT coefficients is set to a small value, whereas a quantization scale corresponding to a high-frequency component is set to a large value. Thus, the high-frequency components are more omitted than the low-frequency components. Note that the control unit 212 adaptively performs variable control of all or part of the quantization scales prescribed in the quantization table. The detailed description of this processing will be given later. The quantization unit 203 also outputs the quantized DCT coefficients to the inverse quantization unit 206.

The variable-length unit 204 entropy-codes the quantized DCT coefficients inputted from the quantization unit 203, the motion vector detected by the motion vector detector 209, other parameters and the like so as to output the entropy-coded results to the output buffer 205.

The output buffer 205 stores temporarily the codestreams inputted from the variable-length coding unit 204 and outputs them, with predetermined timing, to the not-shown recording unit or sends them out to a network. Also, the output buffer 205 outputs the code amount of codestream or the buffer occupancy of the codestream to the control unit 212.

The inverse quantization unit 206 inverse-quantizes the quantized DCT coefficients inputted from the quantization unit 203 and outputs the inverse-quantized DCT coefficients to the inverse orthogonal transform unit 207.

The inverse orthogonal transform unit 207 performs the inverse discrete cosine transform on the inverse-quantized DCT coefficients inputted from the inverse quantization unit 206 so as to restore image frames.

If the image frame supplied from the inverse orthogonal transform unit 207 is an I frame, the adder 208 will store it directly in the frame memory 211. When the image frame supplied from the inverse orthogonal transform unit 207 is a P frame or a B frame, it is a difference image. Thus, the adder 208 adds up the difference image supplied from the inverse orthogonal transform unit 207 and the prediction image supplied from the motion compensation unit 210, so that the original image frame is reconstructed and stored in the frame memory 211.

The motion vector detector 209 uses frames in the past or in the future stored in the frame memory 211, as the reference images. And for each macroblock of P frame or B frame, the motion vector detector 209 searches, from the reference images, a prediction region having the minimum error, then obtains a motion vector indicating a displacement from the macroblock to the prediction region, and outputs said motion vector to the variable-length coding unit 204 and the motion compensation unit 210. Further, for each macroblock in I frame, the motion vector detector 209 also obtains a motion vector and outputs the motion vector to the control unit 212.

The motion compensation unit 210 performs motion compensation using the motion vector inputted from the motion vector detector 209, for each macroblock, then generates a prediction image and outputs the generated prediction image to the difference unit 201 and the adder 208.

The control unit 212 controls the image processing apparatus as a whole. Also, the control unit 212 compares the motion vector inputted from the motion vector detector 209 with a threshold value concerning the magnitude of the motion vector. Then, for each macroblock of I frame, the control unit 212 determines whether each macroblock belongs to a first macroblock group where the magnitude of motion vectors is larger than the threshold value or a second macroblock group which is other than the first macroblock group.

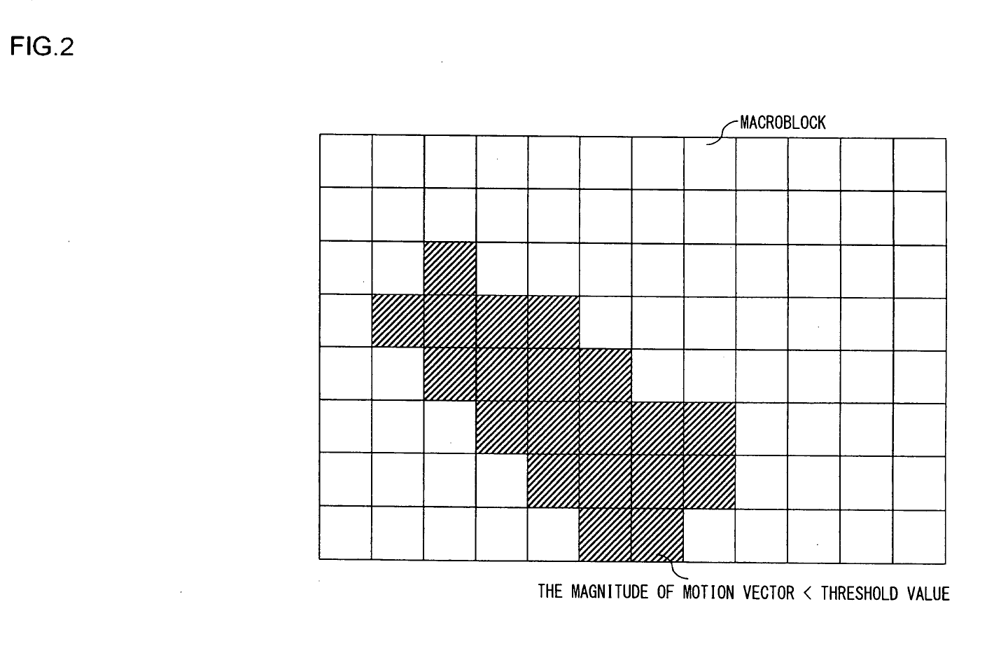

FIG. 2 shows an example where each macroblock of an I frame is grouped into either the first macroblock group or the second macroblock group. In FIG. 2, those sorted out as the first macroblock group (hereinafter referred to as “first macroblock” as appropriate) are indicated with shaded areas. The macroblocks classified as those belonging to the first macroblock group are macroblocks where the size of each motion vector is smaller than a predetermined threshold value, namely, the movement in each of the macroblocks is small. Note that the threshold value may be prescribed as a predetermined value which is set based on simulation runs or experiments and may be adaptively varied according to the code amount inputted from the output buffer 205, for instance.

The control unit 212 controls the quantization unit 203 so that the quantization unit 203 performs an adaptive quantization processing on the first macroblocks. More specifically, the control unit 212 controls the quantization unit 203 in such a manner that the quantization scale used to quantize the first macroblocks is set to a relatively small value.

Accordingly, the control unit 212 variably controls the quantization scale of the quantization table for each macroblock of I frame, based on the code amount of the codestream inputted from the output buffer 205 or the buffer occupancy of the codestream. This mode of control is hereinafter referred to as “first variable control” as appropriate. The first variable control is performed such that the quantization scale is increased when the code amount or buffer occupancy becomes larger whereas the quantization scale is reduced when the code amount or buffer occupancy becomes smaller. Then the control unit 212 performs a variable control in such a manner as to further reduce the quantization scale of the quantization table for the first macroblocks. This mode of control is hereinafter referred to as “second variable control” as appropriate.

In other words, the quantization scale is tentatively determined for the first macroblocks, based on the code amount or buffer occupancy, and it is finally determined by further variably controlling the tentatively determined quantization scale.

In the second variable control of the first macroblocks, the quantization scale which has been tentatively determined by the first variable control is set to a small value in accordance with a predetermined rule. The predetermined rule can be defined through simulation runs or experiments. For example, the quantization scale may be equally reduced by a predetermined number of steps, regardless of the tentatively determined quantization scale. Also, the quantization scale may be reduced by the certain number of steps according to the tentatively determined quantization scale. As a result, the first macroblocks are coded with a high image quality and therefore the accumulation of quantization error can be restricted.

Also, the second variable control may be performed on the quantization scale of the quantization table for each of the first macroblocks and, at the same time, a variable control may be performed such that the quantization scale of the quantization table for macroblocks that belong to the second macroblock group (hereinafter referred to as “second macroblock” as appropriate) is set to a large value. This mode of control is hereinafter referred to as “third variable control” as appropriate.

When the quantization processing for the first macroblocks is performed using a quantization scale determined by the second variable control, the code amount of the first macroblocks increases and is larger than when the quantization processing is performed using a quantization scale determined by the first variable control. Generally, the first variable control is performed to bring the code amount closer to a predetermined value. Since the first macroblocks are coded with a higher image quality by the second variable control, the prediction precision based on the first macroblocks improves. Thus the code amounts of P frame and B frame that reference the first macroblocks can be reduced. As a result, even if the second variable control is performed, the code amount can be brought closer to the predetermined value in terms of a plurality of frames. However, in order that the code amount of I frames only can also be brought closer to the predetermined value, it suffices if an increase in the code amount in the quantization processing of the first macroblocks can be absorbed by the quantization processing of the second macroblocks.

Hence, for the second macroblocks as well, the quantization scale is tentatively determined based on the code amount or buffer occupancy, and it is finally determined by further variably controlling the tentatively determined quantization scale.

In the third variable control for the second macroblocks, the quantization scale which has been tentatively determined by the first variable control is set to a large value in accordance with an increase in the code amount on account of the second variable control. As a result, the code amounts between frames are leveled off and equalized and at the same time the accumulation of quantization error can be reduced.

According to the embodiment of the present invention as described above, the motion vector is also detected for each macroblock of I frame and, the quantization scale of the quantization table is adaptively controlled for the first macroblocks which have been detected as those having the motion vectors smaller than the predetermined value. Thus the prediction precision of coding by referencing the first macroblocks can improve and the fluctuation of image quality can be reduced. In particular, the occurrence of the flicker at the switching from a P picture to an I picture can be suppressed. That is, the accumulation of quantization error caused by the long-continued P pictures can be suppressed and therefore the flicker can be made much less conspicuous. Hence the subjective image quality can be significantly improved.

The description of the invention given above is based upon illustrative embodiments. These exemplary embodiments of the present invention are intended to be illustrative only and thus not limited thereto, and it will be obvious to those skilled in the art that various modifications to constituting elements and processes could be developed and such modifications are also within the scope of the present invention as long as they are within the applicable range of WHAT IS CLAIMED and the functions deriving from the structure of the above-described embodiments are achievable.

Though the image processing apparatus 20 according to the above-described embodiments uses the H.264/AVC standard, for example, for the compression and coding, the image processing apparatus 20 may perform the compression and coding in compliance with MPEG-2, MPEG-4 or other standards.

What is claimed is:

1. An image processing apparatus, comprising:
a coding unit configured to detect a motion vector for each unit region of target picture when the target picture is subjected to intra-frame prediction coding; and
a control unit configured to adaptively control a quantization processing performed by said coding unit for a first unit region whose size of the motion vector is smaller than a predetermined threshold value.

2. An image processing apparatus according to claim 1, wherein said control unit controls said coding unit in such a manner that a first quantization scale used in the quantization of the first unit region becomes small.

3. An image processing apparatus according to claim 2, wherein said control unit controls said coding unit in such a manner that a second quantization scale, used in the quantization of a second unit region, whose size of the motion vector is larger than the predetermined threshold value becomes large according as the first quantization scale used in the quantization of the first unit region becomes small.

4. An image pickup apparatus, comprising:
an image pickup unit configured to acquire moving images; and
an image processing apparatus, according to claim 1, configured to process moving images acquired by said image pickup unit.
